(19) United States
(12) Patent Application Publication
(10) Pub. No.: US 2006/0293108 A1
(43) Pub. Date: Dec. 28, 2006

(54) Solid prop rod of folding type seat

(75) Inventors: Cheolgon Sun, Gimhae-si (KR); Joon-Jae Lee, Yangsan-si (KR); Dong-Woog Oh, Gimhae-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: SUN PREIN CO., LTD., Gimhae-si (KR)

(21) Appl. No.: 11/340,037

(22) Filed: Jan. 26, 2006

(30) Foreign Application Priority Data
Jun. 17, 2005 (KR) 2005-0052552

(51) Int. Cl. F16D 3/06

(52) U.S. Cl. 464/162

(57) ABSTRACT

A sold prop rod for a folding-type seat includes a prop rod body having an end portion, a lock nut coupled to the end portion, a housing engaged with the lock nut, and a rotating member disposed between the end portion of the rod body and the lock nut to permit the rod body to be rotated with respect to the housing.

### CROSS-REFERENCE TO RELATED PATENT APPLICATIONS

This patent application claims the benefit of Korean patent application no. 2005-0052552, filed Jun. 17, 2005, the entire content of which is herein incorporated by reference.

### FIELD OF THE INVENTION

The present invention relates to a solid prop rod of a folding type seat, and more particularly, to a solid prop rod of a folding type seat that permits smooth rotation of the rod with respect to an end socket.

### BACKGROUND

Solid prop rods are widely used in folding type seats of automobiles, airplanes, and transporting vehicles. In a conventional prop rod, such as that shown in FIG. 1, a rod body 1 is rotatably engaged with an end socket 2 such that end socket 2 will not separate from the body 1 of the prop rod. The end socket 2 is injection-molded from a synthetic resin. The end socket 2 is coupled to a ball stud 3. During rotation of the rod, however, wear is generated in the area at which the end socket 2 makes contact with the end portion of the rod body 1. This wear causes the end socket 2 to separate from the rod body 1. Furthermore, the bending force of the rod notably decreases due to the material characteristics of the end socket 2.

### SUMMARY OF THE INVENTION

In accordance with the foregoing, a new and improved solid prop rod is provided. According to an embodiment of the invention, a prop rod assembly includes a prop rod body having an end portion, a lock nut coupled to the end portion, a housing engaged with the lock nut, and a rotating member disposed between the end portion of the rod body and the lock nut to permit the rod body to be rotated with respect to the housing.

In an embodiment, the assembly also has a stopper disposed on the end portion such that the stopper inhibits the axial movement of the rotating member with respect to the rod body.

In an embodiment, the rotating member is a bushing disposed around the end portion, and the lock nut is disposed around the rotating member.

In an embodiment, the rotating member is a bearing mounted between the end portion and the lock nut.

In an embodiment, the end portion has a boss that inhibits longitudinal movement of the prop rod.

In an embodiment, the end portion has a first boss onto which the lock nut and the rotating member are mounted and a second boss onto which a stopper is mounted.

In an embodiment, the first and second bosses are next to one another in a stepped manner.

In an embodiment, the diameter of the second boss is less than the diameter of the first boss.

In an embodiment, the assembly also has an end socket having an inner surface defining a cavity, wherein an outer surface of the housing is coupled to the inner surface.

A further embodiment of the invention is a rod assembly that includes a body having a first end and a second end, the first end having a stepped configuration, the first end having an outer surface. The rod assembly also has a rotation-enhancing member having an inner surface and an outer surface, and disposed such that its inner surface makes contact with the outer surface of the first end of the body. The rod assembly further has a lock nut having an inner surface and an outer surface, the lock nut being disposed such that its inner surface makes contact with the outer surface of the rotation-enhancing member, and a housing having an inner surface and a generally cylindrical cavity, wherein first end is disposed within the generally cylindrical cavity, and wherein the inner surface of the housing is threadingly engaged with the outer surface of the lock nut.

In an embodiment, the rod assembly has a stopper disposed on the first end such that the stopper inhibits the axial movement of the rotation-enhancing member with respect to the body.

In an embodiment, the rotating-enhancing member is a bushing.

In an embodiment, the rotating-enhancing member is a bearing.

In an embodiment, the first end has a boss that inhibits longitudinal movement of the body.

In an embodiment, the first end has a first boss onto which the lock nut and the rotation-enhancing member are mounted and a second boss onto which a stopper is mounted.

In an embodiment, the first and second bosses are next to one another in a stepped manner.

In an embodiment, the diameter of the second boss is less than the diameter of the first boss.

Yet another embodiment of the invention is a rod assembly coupled to a folding seat. The rod assembly includes a rod body having a first end and a second end, the first and second ends being coupled respectively to a first end socket and a second end socket. The first end has a first boss and a second boss adjacent to one another in a stepped configuration. The rod assembly further includes a friction-reducing member disposed around the first boss, a stopper disposed around the second boss, a lock nut disposed around the friction-reducing member, and a housing in contact with an inner surface of the first end surface, the housing being threadingly engaged with the lock nut.

In an embodiment, the friction-reducing member is a boss.

In an embodiment, the friction-reducing member is a bearing.

### BRIEF DESCRIPTION OF THE DRAWINGS

The above and other objects, features and advantages of the present invention will be more apparent from the following detailed description taken in conjunction with the accompanying drawings, in which:

PRIOR ART FIG. 1 is a cross-sectional view for showing a state in which an end socket is engaged with one end portion of a conventional solid prop rod of a folding type seat;

FIG. 2 is a front view for showing a solid prop rod of a folding type seat according to a preferred embodiment of the present invention;

FIG. 3 is a cross-sectional view taken along line A-A′ of FIG. 2;

FIG. 4 is an exploded perspective view of FIG. 3;

FIG. 5 is a front view for showing a solid prop rod of a folding type seat according to another preferred embodiment of the present invention;

FIG. 6 is a cross-sectional view taken along line B-B′ of FIG. 5; and

FIG. 7 is an exploded perspective view of FIG. 6.

### DETAILED DESCRIPTION

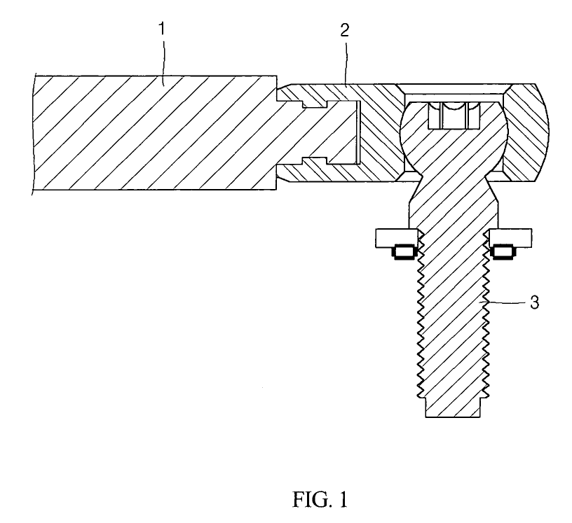

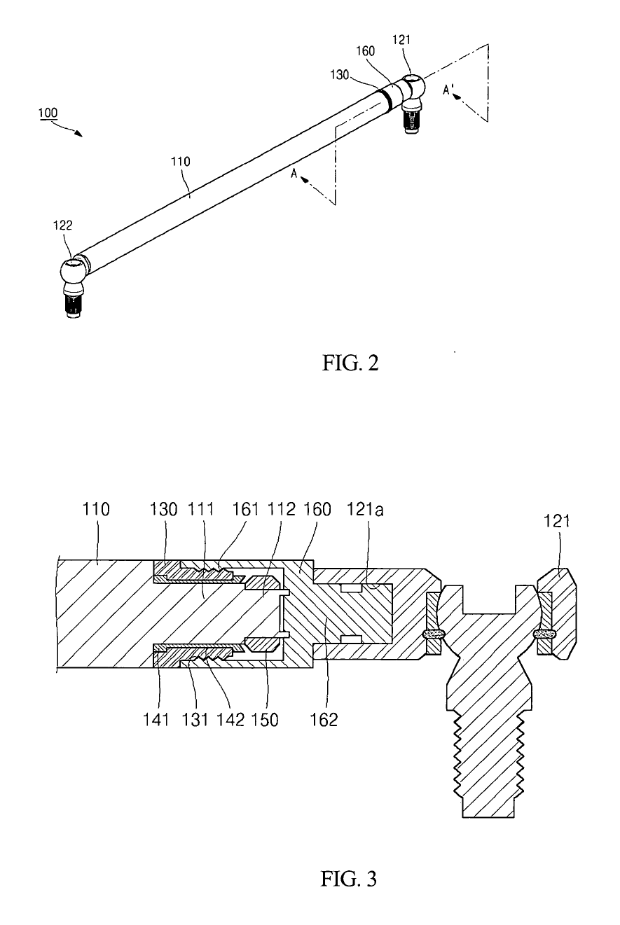

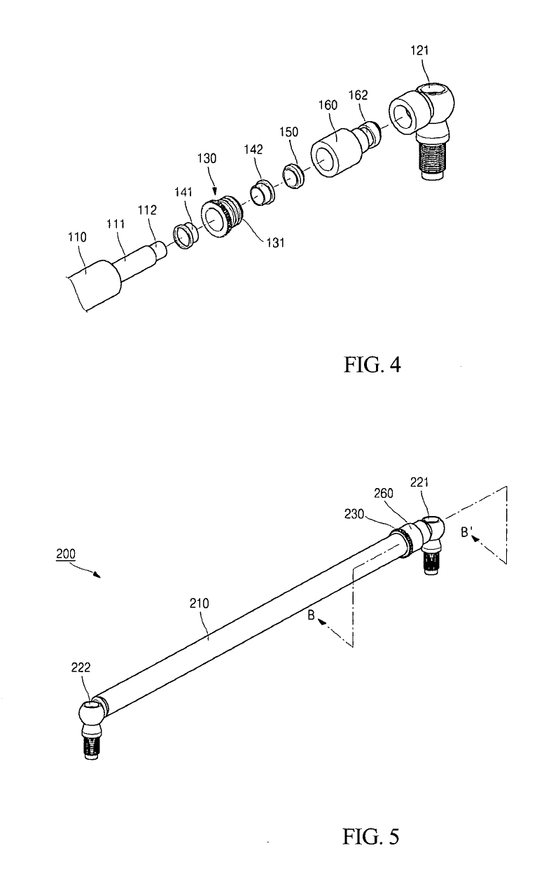

Referring to FIGS. 2 to 4, a prop rod 100 according to an embodiment of the invention is shown. The prop rod 100 includes first and second end sockets 121 and 122. The first end socket 121 is rotatably coupled with the first end of the rod body 110, and the second end socket 122 is coupled to the second end portion of the rod body 110.

Referring to FIGS. 3 & 4, a bushing assembly is disposed between the first end of the rod body 110 and the first end socket 121. A first boss 111 into which the bushing assembly is inserted is formed at the first end of the rod body 110. The bushing assembly includes a first bushing 141 and a second bushing 142. A lock nut 130 is engaged with the first boss 111 of the rod body 110 between the first bushing 141 and the second bushing 142.

A second boss 112 having a diameter smaller than that of the first boss 111 extends from an end of the first boss 111 in a stepped manner.

The first bushing 141 is engaged with the first boss 111 and the lock nut 130. The second bushing 142 is engaged with the second boss 112 and is fixed to the second boss 112 by a rivet. A stopper 150 is disposed around the second boss 112 to prevent displacement of the nearby components.

The bushing assembly further includes a housing 160. The first end socket 121 is engaged with the housing 160 which, in turn, is engaged to the lock nut 130. A screw portion 161 formed on the inner peripheral surface of the housing 160 is engaged with a screw portion 131 formed on the outer peripheral surface of the lock nut 130.

The housing 160 includes an engaging boss 162 formed on one side of the housing 160. The engaging boss 162 is caulked and engaged in a state in which it is inserted into the interior of an engaging recess 121a of the first end socket 121.

The manner in which the end socket is assembled to the prop rod according to an embodiment of the invention will be now described. First, the first bushing 141, the lock nut 130, and the second bushing 142 are sequentially mounted onto the rod body 110. Then, the first and second bushings 141 and 142 are interposed between the lock nut 130 and the first boss 111, and the lock nut 130 is rotatably engaged with the first boss 111. Thereafter, the stopper 150 is riveted to the second boss 112 of the rod body 110 to prevent the first and second bushings 141 and 142 and the lock nut 130 from being deviated from the first boss 111. Then, the end socket engaging housing 160 is caulked to the end socket 121. The end socket engaging housing 160 is engaged with the lock nut 130 to finish the assembly. Then, the first end socket 121 is rotatably engaged at one end of the rod 110.

The operation of the prop rod according to an embodiment of the invention will now be described. When a seat is folded or unfolded, the prop rod 110 is inclined and is rotated with respect to the axial direction. The end socket 121 is then engaged with the end socket engaging housing 160, and is fixed to the lock nut 130. Since the first and second bushings 141 and 142 are interposed between the lock nut 130 and the rod, the body 110 of the rod is smoothly rotated with respect to the first end socket 121.

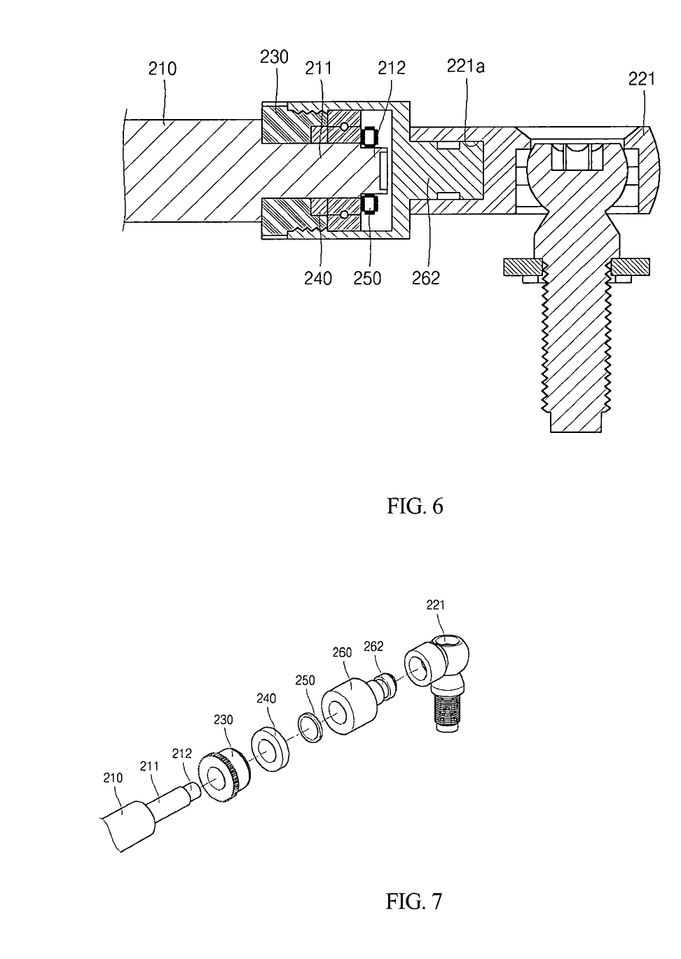

Referring to FIGS. 5-7, a solid rod prop according to another embodiment of the invention will now be described. The prop rod 200 is similar to the prop rod 100 previously described, in that first and second end sockets 221 and 222 are engaged with both ends of a rod body 210 and a first boss 211 and a second boss 212 are formed at one end portion of the rod body 210. A lock nut 230 is mounted onto the first boss 211 of the rod body 210 and a bearing 240 is mounted onto the first boss 211 of the rod body 210. A stopper 250 is mounted to the second boss 212 and is fixed by a rivet. The stopper 250 prevents displacement of the lock nut 230 and the bearing 240 mounted onto the first boss 211.

Referring still to FIGS. 5-7, the first end socket 221 is engaged with an end socket engaging housing 260 and then with the lock nut 230. Then, the end socket engaging housing 260 is engaged with the lock nut 230 in a screw manner and is fixed to the lock nut 230. An engaging boss 262 is formed on one side of the end socket engaging housing 260, and caulked in a state in which it is inserted into the interior of an engaging recess 221a of the first end socket 221.

To assemble the prop rod of FIGS. 5-7 according to an embodiment of the invention, the lock nut 230 is mounted to the first boss 211 of the rod body 210, and the bearing 240 is mounted to the rear end of the first boss 211. A stopper 250 is riveted to the second boss 212 of the rod body 210. After the end socket engaging housing 260 is caulked and fixed to the first end socket 221, the end socket engaging housing 260 is engaged with the lock nut 230 to finish the assembly. The first end socket 221 is rotatably engaged with one end of the rod body 210 using the bearing 240.

Because the first end socket 221 is engaged with the end socket engaging housing 260 and fixed to the lock nut 230 and the bearing 240 is mounted to the first boss 211 of the rod and makes contact with the inner peripheral surface of the end socket engaging housing 260, the rod body 210 is able to be smoothly rotated with respect to the first end socket 221. When used in conjunction with a seat according to an embodiment of the invention, the prop rod is inclined when the seat is folded or unfolded.

Although, in an embodiment of the invention, the first end socket is engaged with the end socket engaging housing 260, and the end socket is rotatably engaged with one end portion of the rod by engaging the end socket engaging housing to the lock nut, it is possible to exclude the end socket engaging housing and rotatably engage the end socket at one end portion of the rod by directly engaging the end socket with the lock nut.

In the embodiments of the solid prop rod described herein, the rod does not make contact with the end socket directly by the rotating members of the bushing and the bearing. Therefore, when the seat is folded or unfolded, the rod is smoothly rotated and wear and noise are prevented. Further, since the rod body and the end socket are connected by the end socket engaging housing of a metal material, the bending force of the rod improves.

Although preferred embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A solid prop rod assembly for supporting a folding seat, the solid prop rod assembly comprising:
a prop rod body having an end portion;
a lock nut coupled to the end portion;
a housing engaged with the lock nut; and
a rotating member disposed between the end portion of the rod body and the lock nut to permit the rod body to be rotated with respect to the housing.

2. The assembly of claim 1, further comprising a stopper disposed on the end portion such that the stopper inhibits the axial movement of the rotating member with respect to the rod body.

3. The assembly of claim 1, wherein the rotating member is a bushing disposed around the end portion, and the lock nut is disposed around the rotating member.

4. The assembly of claim 1, wherein the rotating member is a bearing mounted between the end portion and the lock nut.

5. The assembly of claim 1, wherein the end portion comprises a boss that inhibits longitudinal movement of the prop rod.

6. The assembly of claim 1, wherein the end portion comprises a first boss onto which the lock nut and the rotating member are mounted and a second boss onto which a stopper is mounted.

7. The assembly of claim 6, wherein the first and second bosses are next to one another in a stepped manner.

8. The assembly of claim 7, wherein the diameter of the second boss is less than the diameter of the first boss.

9. The assembly of claim 1, further comprising an end socket having an inner surface defining a cavity, wherein an outer surface of the housing is coupled to the inner surface.

10. A rod assembly comprising:
a body having a first end and a second end, the first end having a stepped configuration, the first end having an outer surface;
a rotation-enhancing member having an inner surface and an outer surface, the rotation-enhancing member being disposed such that its inner surface makes contact with the outer surface of the first end of the body;
a lock nut having an inner surface and an outer surface, the lock nut being disposed such that its inner surface makes contact with the outer surface of the rotation-enhancing member; and
a housing having an inner surface a generally cylindrical cavity, wherein first end is disposed within the generally cylindrical cavity, and wherein the inner surface of the housing is threadingly engaged with the outer surface of the lock nut.

11. The assembly of claim 10, further comprising a stopper disposed on the first end such that the stopper inhibits the axial movement of the rotation-enhancing member with respect to the body.

12. The assembly of claim 10, wherein the rotating-enhancing member is a bushing.

13. The assembly of claim 10, wherein the rotating-enhancing member is a bearing.

14. The assembly of claim 10, wherein the first end comprises a boss that inhibits longitudinal movement of the body.

15. The assembly of claim 10, wherein the first end comprises a first boss onto which the lock nut and the rotation-enhancing member are mounted and a second boss onto which a stopper is mounted.

16. The assembly of claim 15, wherein the first and second bosses are next to one another in a stepped manner.

17. The assembly of claim 16, wherein the diameter of the second boss is less than the diameter of the first boss.

18. A rod assembly coupled to a folding seat, the rod assembly comprising:
a rod body having a first end and a second end, the first and second ends being coupled respectively to a first end socket and a second end socket,
wherein the first end comprises a first boss and a second boss adjacent to one another in a stepped configuration;
a friction-reducing member disposed around the first boss;
a stopper disposed around the second boss;
a lock nut disposed around the friction-reducing member; and
a housing in contact with an inner surface of the first end surface, the housing being threadingly engaged with the lock nut.

19. The assembly of claim 18, wherein the friction-reducing member is a boss.

20. The assembly of claim 18, wherein the friction-reducing member is a bearing.
